(19) United States
(12) Patent Application Publication
(10) Pub. No.: US 2020/0314309 A1
(43) Pub. Date: Oct. 1, 2020

(54) IMAGE PROCESSING DEVICE, IMAGE CAPTURING DEVICE, AND IMAGE PROCESSING METHOD

(71) Applicant: SHARP KABUSHIKI KAISHA, Sakai City, Osaka (JP)

(72) Inventors: RYUHJI KITAURA, Sakai City, Osaka (JP); KEI TOKUI, Sakai City, Osaka (JP)

(21) Appl. No.: 16/761,985

(22) PCT Filed: Oct. 18, 2018
(86) PCT No.: PCT/JP2018/038778

§ 371 Date: May 6, 2020

(30) Foreign Application Priority Data
Nov. 10, 2017 (JP) 2017-217540

(51) Int. Cl. H04N 5/225; H04N 5/232; H04N 5/235

(52) U.S. Cl. CPC H04N 5/2258; H04N 5/23219; H04N 5/2351; H04N 5/23245

(57) ABSTRACT

An image processing device includes: an obtaining unit configured to obtain a first image and a second image larger in angle of view than the first image; a detector configured to detect from the first image a first subject to be a main subject; and a composition corrector configured to correct the second image to have a composition in which a second subject, included in the second image and corresponding to the first subject, is the main subject, and to output a corrected image generated by correcting the second image.

### TECHNICAL FIELD

The present invention relates to an image processing device, an image processing method, and a program.

The present application claims priority to Japanese Patent Application No. 2017-217540, filed Nov. 10, 2017, the contents of which are incorporated herein by reference in its entirety.

### BACKGROUND ART

A known image processing device estimates a main subject from a captured image and crops a part of the captured image to correct the composition of the image

Furthermore, an image processing device equipped with a plurality of capturing units each having a different angle of view can obtain a telephoto image and a wide-angle image in a single capturing operation.

Patent Document 1 discloses a capturing device and a capturing method thereof. The capturing device includes two capturing units each having a different angle of view. The capturing device allows a user to change a cropping area in a wide-angle image displayed on a display, and obtains a telephoto image and a trimmed-and-wide image which is cropped from the wide-angle image to include a subject.

### CITATION LIST

### Patent Literature

[Patent Document 1] Japanese Unexamined Patent Application Publication No. 2011-211552 (published on Oct. 20, 2011)

### SUMMARY OF INVENTION

### Technical Problem

The capturing device and the capturing method disclosed in Patent Document 1 have a drawback; that is, a size of the cropping area in the wide-angle image is determined based on a focal point (a capturing magnification) of one of the capturing units, and the cropping position has to be adjusted by the user. Specifically, depending on a scene to be captured, a size not automatically determined based on the focal point could be more appropriate for cropping. Furthermore, if the user is not sufficiently knowledgeable on the composition, and insufficiently adjusts the cropping position, the resulting trimmed-and-wide image (a corrected image) might not have an appropriate composition.

The present invention is conceived in view of the above problems, and intends to provide an image processing device, an image capturing device, an image processing method, and a program to facilitate outputting a corrected image whose composition is ideally corrected.

### Solution to Problems

In order to solve the above problems, an image processing device according to an aspect of the present invention includes: an obtaining unit configured to obtain a first image and a second image larger in angle of view than the first image; a detector configured to detect from the first image a first subject to be a main subject; and a composition corrector configured to correct the second image to have a composition in which a second subject, included in the second image and corresponding to the first subject, is the main subject, and to output a corrected image generated by correcting the second image.

An image capturing device according to an aspect of the present invention includes: a first capturing unit configured to capture a first image; a second capturing unit configured to capture a second image larger in angle of view than the first image; an obtaining unit configured to obtain the first image and the second image larger in angle of view than the first image; a detector configured to detect from the first image a first subject to be a main subject; a composition corrector configured to correct the second image to have a composition in which a second subject, included in the second image and corresponding to the first subject, is the main subject, and to output a corrected image generated by correcting the second image; and a display configured to display the corrected image.

An image processing method according to an aspect of the present invention includes: obtaining a first image and a second image larger in angle of view than the first image; detecting from the first image a first subject to be a main subject; and correcting the second image to have a composition in which a second subject, included in the second image and corresponding to the first subject, is the main subject, and outputting a corrected image generated in correcting the second image.

### Advantageous Effects of Invention

An aspect of the present invention can provide an image processing device, an image capturing device, an image processing method, and a program which make it possible to easily output a corrected image whose composition is ideally corrected.

### BRIEF DESCRIPTION OF DRAWINGS

FIG. 1 is a block diagram illustrating an example of a schematic configuration of an image processing device according to a first embodiment of the present invention.

FIG. 2 is an illustration showing an example of a symmetrical composition.

FIG. 3 is an illustration showing an example of a three-way split composition.

FIG. 4 is an illustration showing an example of a centering composition.

FIG. 5 is an illustration showing an example of a diagonal composition.

FIG. 6 is an illustration showing an example of a triangular composition.

FIG. 7 is an illustration showing an example of how to correct a composition of a telephoto image.

FIG. 8 is an illustration showing an example of how a composition corrector selects a composition of a wide-angle image.

FIG. 9 is an illustration showing another example of how the composition corrector selects a composition of the wide-angle image.

FIG. 10 is a flowchart showing an example of image processing by the image processing device according to the first embodiment of the present invention.

FIG. 11 is a flowchart showing an example of image processing by an image processing device according to a second embodiment of the present invention.

FIG. 12 is a block diagram illustrating a schematic configuration of a modification of the image processing device according to the second embodiment.

FIG. 13 is a flowchart showing an example of image processing by an image processing device according to a third embodiment of the present invention.

FIG. 14 is a flowchart showing an example of image processing by an image processing device according to a fourth embodiment of the present invention.

FIG. 15 is a block diagram illustrating an example of a schematic configuration of an image capturing device according to a fifth embodiment of the present invention.

FIG. 16 is a flowchart showing an example of image processing by the image capturing device according to the fifth embodiment of the present invention.

### DESCRIPTION OF EMBODIMENTS

Described below in detail are the embodiments of the present invention, with reference to the drawings. The drawings merely illustrate specific embodiments on the bases of the present invention. These embodiments are presented to understand the present invention, and shall not be presented for limited interpretation of the present invention. In addition, the constituent features in the attached drawings are emphatically illustrated to help gain better understanding of the present invention. Note that actual intervals between, and sizes of, the constituent features shall be different.

In the detailed description that follows, identical constituent features have the same reference numerals, regardless of whether they are shown in different drawings. Such constituent features will not be repeatedly elaborated. Moreover, the term “image” described below shall be interpreted to include both a still image and a moving image. Furthermore, if the moving image include audio information, the term “image” shall be interpreted to include audio information.

### First Embodiment

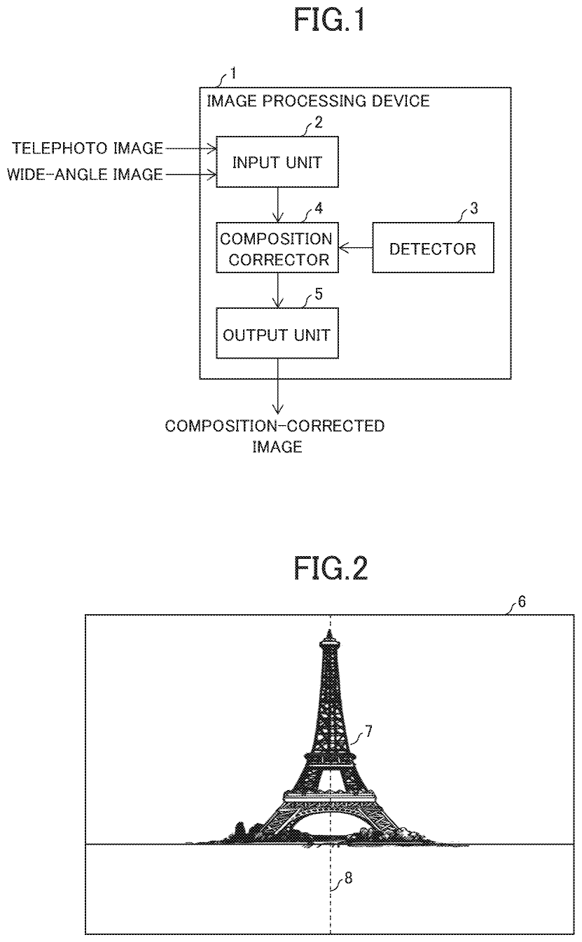

Described below is an image processing device 1 according to a first embodiment of the present invention, with reference to FIGS. 1 to 10.

Image Processing Device 1

FIG. 1 is a functional block diagram illustrating a configuration of an image processing device 1 according to the first embodiment of the present invention. As illustrated in FIG. 1, the image processing device 1 includes an input unit (an obtaining unit) 2, a detector 3, a composition corrector 4, and an output unit 5. In the image processing device 1 according to this embodiment, the input unit 2 illustrated in FIG. 1 obtains image information on a first image and a second image. Then, the output unit 5 of the image processing device 1 outputs a corrected image (an output image). The corrected image is the second image whose composition is corrected by the composition corrector 4.

Here, the second image is larger in angle of view than the first image. For the sake of simplifying the description, the first image and the second image respectively denote a telephoto image and a wide-angle image.

Input Unit 2

The input unit 2 obtains the image information on a plurality of images including the same subject and each having a different angle of view. Specifically, the input unit 2 obtains a telephoto image and a wide-angle image. The image information obtained by the input unit 2 may be, for example, obtained by a capturing element and stored in a not-shown storage unit.

Detector 3

The detector 3 detects from the telephoto image a first subject to be a main subject. In this embodiment, the detector 3 detects the first subject by face detection and feature-point extraction. The face detection is achieved by conventionally known techniques. Examples of such techniques include detecting a face by extracting a skin color region in a telephoto image and matching a telephoto image with data which indicates face information. The feature-point extraction includes various kinds of processing for extracting feature points of an image. Examples of the processing include edge detection, corner detection, and line detection. The detector 3 according to this embodiment is advantageous because of its capability to ideally detect the main subject, especially if the main subject is a face.

Composition Corrector 4

The composition corrector 4 corrects a composition of the wide-angle image with reference to main subject information on the first subject in the telephoto image, and generates (outputs) a corrected image. The composition corrector 4 corrects the wide-angle image to have a predetermined composition in which the second subject, in the wide-angle image and corresponding to the first subject, is the main subject, and outputs the corrected image generated by correcting the wide-angle image. Such a feature makes it possible to easily output the corrected image whose composition is ideally corrected.

Moreover, the composition corrector 4 calculates a correction amount for the correction of the wide-angle image, and, based on the calculated correction amount, corrects the composition of the wide-angle image to output the corrected image. The composition corrector 4 outputs the corrected image based on the calculated correction amount. Such a feature makes it possible to output a more accurately and ideally corrected image.

In one aspect, the composition corrector 4 may correct the wide-angle image to output the corrected image, based on a position of the first subject in the telephoto image. The composition of the wide-angle image is corrected to be the predetermined composition based on the position of the first subject in the telephoto image. Such a feature makes it possible to output the corrected image whose composition is ideally corrected, so that the second subject; that is, the main subject in a second composition, is kept from lying out of the wide-angle image.

Moreover, examples of the predetermined composition include a symmetrical composition, a three-way split composition, a centering composition, a diagonal composition, and a triangular composition. The composition corrector 4 corrects the composition of the wide-angle image to have any one of the compositions, making it possible to output a corrected image having a more ideal composition.

Symmetrical Composition, Three-Way Split Composition. Centering Composition. Diagonal Composition, and Triangular Composition

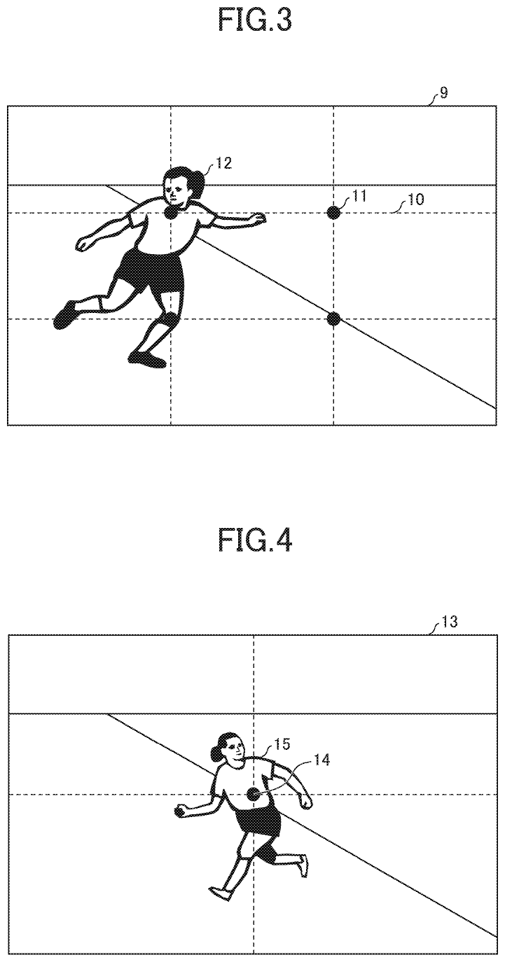

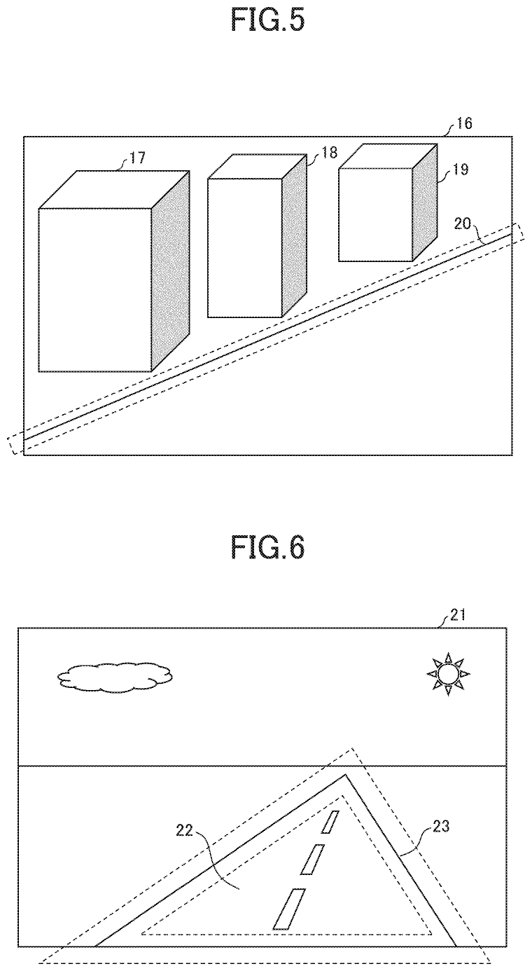

Described below are the symmetrical composition, the three-way split composition, the centering composition, the diagonal composition, and the triangular composition, with reference to FIGS. 2 to 6. FIG. 2 is an illustration showing an example of the symmetrical composition. FIG. 3 is an illustration showing an example of the three-way split composition. FIG. 4 is an illustration showing an example of the centering composition. FIG. 5 is an illustration showing an example of the diagonal composition. FIG. 6 is an illustration showing an example of the triangular composition.

As illustrated in FIG. 2, a symmetrical composition 6 symmetrically presents a second subject 7 in relation to an image center line 8. As illustrated in FIG. 3, the three-way split composition 9 splits an image into three, and presents a second subject 12 at any one of split points 11 each of which is a point where a plurality of split lines 10 intersect. As illustrated in FIG. 4, a centering composition 13 presents a second subject 15 in a center 14 of an image. As illustrated in FIG. 5, a diagonal composition 16 diagonally presents second subjects 17 to 19 and an edge 20 in an image. As illustrated in FIG. 6, a triangular composition 21 triangularly presents a second subject 22 and an edge 23 in an image.

The composition corrector 4 selects a composition, from among the compositions expected above, for a corrected image to be generated by correcting a wide-angle image.

For example, the composition corrector 4 calculates scores indicating whether a second subject in each of the expected compositions is appropriately positioned, and compares the scores calculated for the compositions to select a composition for the corrected image generated by correcting the wide-angle image.

In the case of the symmetrical composition 6, the composition corrector 4 calculates a score by matching symmetrical degrees of the second subject 7 in relation to the image center line 8; that is, by measuring how far the second subject 7 is offset from the image center line 8.

In the case of the three-way split composition 9, the composition corrector 4 calculates a score by measuring how far the position of the second subject 12 is away from the split point 11 proximate to the second subject 12 of all the split points 11 where the split lines 10 intersect.

In the case of the centering composition 13, the composition corrector 4 calculates a score by measuring how far the position of the second subject 15 is away from the center 14 of the image.

In the case of the diagonal composition 16, the composition corrector 4 calculates a score by measuring the length of the edge 20 (a diagonal line) along which the second subjects 17 to 19 are arranged or the number of points where the diagonal line intersects with the second subjects 17 to 19.

In the case of the triangular composition 21, the composition corrector 4 calculates a score by measuring the area, the shape, and the barycenter of the second subject 22. The composition corrector 4 calculates a higher score as the second subject 22 has a larger area. The composition corrector 4 calculates a higher score as the second subject 22 is shaped closer to a regular triangle or an isosceles triangle. Moreover, the composition corrector 4 calculates a higher score as the barycenter of the second subject 22 is positioned closer to the center of the image.

The composition corrector 4 selects as a composition for the corrected image the composition whose score is highest of all the scores calculated for the compositions. Specifically, the composition corrector 4 determines from among the compositions a composition most suitable to the position of the second subject in the wide-angle image, and selects the determined composition for correcting the wide-angle image to generate the corrected image. Such a feature makes it possible to easily output a corrected image whose composition is ideally corrected.

If two or more compositions with the highest score are found, the compositions may be previously prioritized. Hence, the composition corrector 4 may select the composition with the highest priority. Moreover, the composition corrector 4 may allow the user to select any one of the compositions with the highest score. Here, the composition corrector 4 can obtain information on the composition selected by the user through, for example, the input unit 2.

Note that, in the above example, the composition corrector 4 may select a composition of the corrected image by comparing the scores calculated for the compositions. However, the selection in this embodiment shall not be limited to the example. In this embodiment, the composition corrector 4 may prioritize the compositions, and compare the scores calculated for the compositions with a preset threshold. When a score calculated for a composition exceeds the threshold, the composition corrector 4 may select the composition for the corrected image. Such a feature makes it possible to output a corrected image whose composition is ideally corrected for the wish of the user.

Note that, in the above example, the composition corrector 4 may rotate the wide-angle image as necessary to select a composition, and partially crop the wide-angle image to generate the corrected image. Here, while changing a rotation amount X1, a cropping position X2, and an area X3 in relation to the wide-angle image before correction, the composition corrector 4 may select a composition whose rotation amount X1, cropping position X2, and area X3 mark the highest scores.

Correction of Composition

Using factors such as a position and an area, of the second subject, expected after the wide-angle image is corrected to have the selected composition, the composition corrector 4 calculates a correction amount of the position of the second subject in the wide-angle image before correction, and outputs the corrected image based on the correction amount. The correction amount here is a rotation amount Y1, a translation amount Y2, and an area correction amount Y3 of the wide-angle image. The rotation amount Y1 is an amount of rotation in which the second subject moves from the wide-angle image before correction to the wide-angle image after correction. The translation amount is an amount of translation in which the second subject moves from the composition before correction to the composition after correction. The area correction amount is a correction amount of: an area of the wide-angle image after the composition correction in relation to the wide-angle image of before the composition correction; or the number of vertical and horizontal pixels.

The composition corrector 4 outputs the corrected image based on at least one of the above factors to be these correction amounts.

Note that the composition corrector 4 respectively calculates the rotation amount Y 1, the translation amount Y2, and the area correction amount Y3 from the rotation amount X1, the cropping position X2, and the area X3 of the wide-angle image in the selected composition. For example, the composition corrector 4 may calculate: the value of the rotation amount Y1 as the X1; the value of the translation amount Y2 as the −X2; and the value of the area correction amount Y3 as a difference in size between the area X3 and the image before correction.

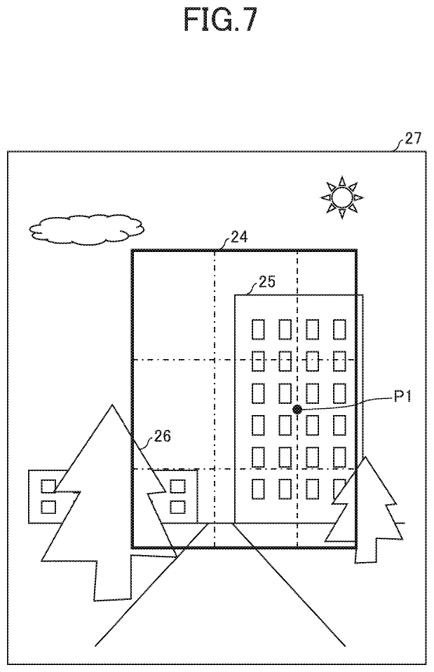

Here, the first image; namely the telephoto image, is the first subject enlarged. Hence, the first subject might be positioned at an end of the image or not the whole first subject might fit in the image. If the first subject is positioned at an end of the telephoto image or if not the whole first subject fits in the telephoto image when the composition of the telephoto image is corrected, the composition cannot obtain a sufficient correction effect. With reference to FIG. 7, described below is how to correct the composition of the telephoto image. FIG. 7 is an illustration showing an example of how to correct a composition of a telephoto image. If the image area of the telephoto image is an image area 24 as illustrated in FIG. 7, a subject (the first subject) 25 is positioned at an end of the image, and thus cannot sufficiently be translated. Hence, the composition cannot obtain a sufficient correction effect.

Meanwhile, a wide-angle image could present therein a plurality of subjects. If the plurality of subjects are presented when the composition of the wide-angle image is corrected, the correction is to be made based on a main subject estimated by the detector 3 with face recognition or feature-point detection. Hence, the composition correction might be made to a subject different from the main subject of the user's wish. For example, in FIG. 7, if the image area of the wide-angle image is the image area 27 presenting the entire scene, the main subject of the user's wish is supposed to be the subject 25. However, a subject 26 might be inadvertently determined as the main subject whose composition is to be corrected.

In contrast, the telephoto image and the wide-angle image of the image processing device 1 according to this embodiment present the same scene. The composition corrector 4 analyzes the first subject in, and the composition of, the telephoto image, and then analyzes the composition of the wide-angle image. Hence, if the same scene is captured in both the telephoto image and the wide-angle image, a subject in the telephoto image is to be estimated as the first subject. Moreover, the composition corrector 4 corrects the composition, so that a subject in the wide-angle image and identical to the subject in the telephoto image is positioned to correspond to the subject in the telephoto image.

Such a feature makes it possible to output a corrected image whose composition is appropriately corrected so that the second subject, which is the main subject of the user's wish in the scene, is placed in an ideal position. Moreover, the wide-angle image allows a cropping area to be determined more freely, reducing the risk that the second subject could be positioned out of the angle of view. Hence, the composition corrector 4 can easily and ideally output the composition of the wide-angle image without the adjustment by the user.

Specific Example of how to Correct Composition

Described below is a specific example of how to correct a composition by the composition corrector 4, with reference to FIGS. 7 to 9. First, the detector 3 estimates by face detection or feature-point detection that the subject 25 is the first subject of the user's wish in the image area 24 of the telephoto image in FIG. 7. Here, the composition corrector 4 determines information indicating a region of the subject 25 as main subject information. Next, the composition corrector 4 corrects the composition of the wide-angle image with reference to the main subject information on the subject 25. The composition corrector 4 selects a composition in which the second subject in the wide-angle image is ideally positioned. Here, the second subject corresponds to the subject 25, that is, the first subject in the telephoto image.

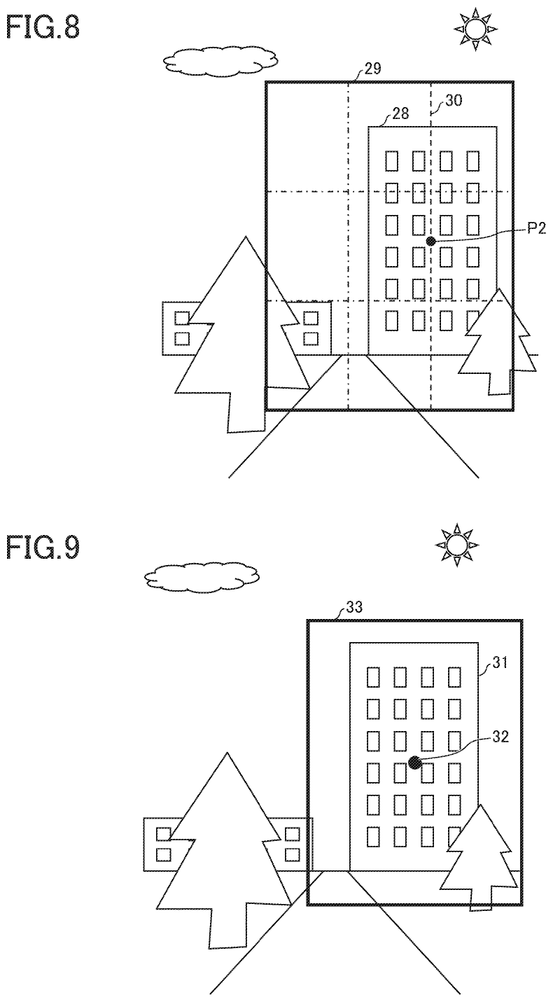

Described below is an example of how the composition corrector 4 selects a composition in which the second subject is ideally positioned, with reference to FIGS. 8 and 9. FIGS. 8 and 9 are illustrations showing an example of how the composition corrector 4 selects a composition of the wide-angle image. As FIG. 8 shows, for example, if a subject 28 (i.e., the second subject) is close to a dotted line 30 (i.e., a composition line of a three-way split composition 29), the composition corrector 4 preferentially selects the three-way split composition 29 as the composition for the corrected image. Meanwhile, as FIG. 9 shows, if a barycenter of a subject 31 (i.e., the second subject) is close to a center 32, the composition corrector 4 preferentially selects a centering composition 33 as the composition for the corrected image.

In the above example, the composition corrector 4 calculates the main subject information from the telephoto image. Alternatively, the composition corrector 4 may calculate the main subject information from the wide-angle image, based on the first subject in the telephoto image. Such a feature also makes it possible to obtain the same advantageous effects as those described in the above feature. For example, based on a capturing condition of the telephoto image and the wide-angle image, the composition corrector 4 may estimate a subject, found in the area (i) captured in the telephoto image and (ii) presented in the wide-angle image, as the main subject corresponding to the first subject. Then, the composition corrector 4 may analyze the main subject and weigh a result of the subject analysis. Moreover, the composition corrector 4 performs matching of the telephoto image within the wide-angle image to estimate an area which is included in the wide-angle image and in which the telephoto image is captured. Then, the composition corrector 4 may analyze the subject and weigh the result of the subject analysis within the estimated area.

Furthermore, the main subject information may include information indicating an importance for each of the subjects. For example, if two or more subjects are found, the composition corrector 4 refers to the information indicating the importance for each subject and determines a subject having the highest importance as the second subject. In addition, when a subject having a high importance is placed in an ideal position in the image and the composition corrector 4 selects a composition in which a subject having a low importance is placed in the image, the composition corrector 4 can correct the composition corresponding to two or more subjects. Note that if the main subject information includes information indicating that the telephoto image does not present the first subject, the composition corrector 4 may perform the main subject analysis within the wide-angle image to calculate the main subject information, and correct the composition.

Output Unit 5

The output unit 5 outputs image information on the corrected image to a not-shown display or to a not-shown storage unit in an image capturing device to be described later.

Image Processing

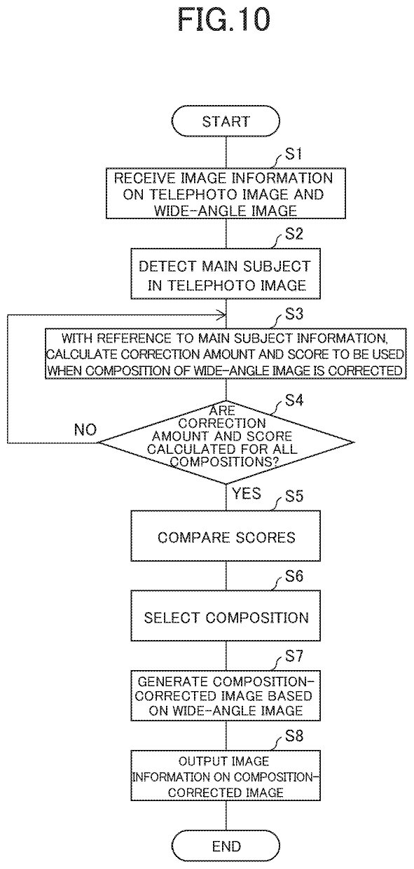

Described below is image processing (an image processing method) of the image processing device 1 according to this embodiment, with reference to FIG. 10. FIG. 10 is a flowchart showing an example of the image processing by the image processing device 1.

The image processing device 1 according to this embodiment executes steps S1 to S8 described below to perform determination processing.

Step S1: The input unit 2 of the image processing device 1 receives image information on a plurality of images presenting the same subject and each having a different angle of view. Here, the images include a telephoto image and a wide-angle image. That is, the input unit 2 obtains the telephoto image and the wide-angle image (obtaining).

Step S2: The detector 3 of the image processing device 1 detects from the telephoto image the first subject to be the main subject (detecting).

Step S3: With reference to the main subject information on the detected first subject, the composition corrector 4 of the image processing device 1 calculates a correction amount and a score for each of the compositions to be expected when the wide-angle image is corrected to have the composition.

Step S4: The composition corrector 4 determines whether the correction amount and the score are calculated for all the compositions of the wide-angle image to be corrected. If the composition corrector 4 determines that the correction amount and the score are not calculated even for one of the compositions (Step S4: NO), the process goes back to Step S3. If the composition corrector 4 determines that the correction amount and the score are calculated for all the compositions, (Step S4: YES), the processing proceeds to Step S5.

Step S5: The composition corrector 4 compares the scores of the compositions for the wide-angle image to be corrected.

Step S6: The composition corrector 4 selects a composition having the highest score of all the scores of the compositions as the composition for a corrected image. That is, the composition corrector 4 selects a composition in which the second subject in the wide-angle image is positioned most ideally.

Step S7: Based on the selected composition and correction amount, the composition corrector 4 corrects to output the wide-angle image to have the composition in which the main subject is the second subject presented in the wide-angle image and corresponding the first subject. Hence, the composition corrector 4 outputs the corrected image (correcting composition).

Step S8: The output unit 5 outputs image information on the corrected image (outputting).

In the above image processing, the image processing device 1 can output a corrected image in which the second subject of the user's wish is ideally positioned.

Modification 1 of Composition Corrector 4

In the above example, the composition corrector 4 calculates the score of, and selects, a composition based only on the wide-angle image. Alternatively, in this embodiment, the composition corrector 4 may determine the composition of the corrected image based on the position of the first subject (a subject) in the telephoto image.

For example, in the telephoto image, the composition corrector 4 outputs as composition point information a composition point P1 positioned closest to the center of the first subject. Then, when calculating a score of a composition using the wide-angle image, the composition corrector 4 refers to the composition point information and calculates a composition point P2 found in the same position as the composition point P1 in the corrected image. Hence, the composition corrector 4 outputs the corrected image in which the second subject is positioned at the composition point P2. As an example, in FIG. 7, the subject 25; namely, the first subject, is positioned on the composition line in the right of the three-way split composition in the telephoto image. Hence, the composition corrector 4 determines that the composition line in the right of the three-way split composition is the composition point P1. Then, in FIG. 8, the composition corrector 4 selects the three-way split composition 29 so that the second subject; namely, the subject 28, is positioned on the dotted line 30; that is, the composition point P2 presented in the wide-angle view and corresponding to the composition point P1 of the telephoto view. Such features allow the second subject, corresponding to the first subject of the user's wish in the telephoto image, to be positioned in a point in the composition of the user's wish in the wide-angle image, making it possible to output a more ideally corrected image.

Modification 2 of Composition Corrector 4

When correcting a composition using the wide-angle image, the composition corrector 4 does not have to select a composition in which a proportion of the second subject to be presented in the corrected image is equal to or less than a threshold. Such a feature makes it possible to correct a composition so that the size of the second subject is kept from being excessively reduced in the corrected image. As a result, the second subject of the user's wish is more likely to catch attention, making it possible to output a more ideally corrected image.

### Second Embodiment

In the first embodiment, the composition corrector 4 of the image processing device 1 always outputs a corrected image regardless of the value of a correction amount. Alternatively, in a second embodiment, the composition corrector 4 may act as a not-shown composition corrector 54 which keeps from outputting a corrected image depending on the value of a correction amount.

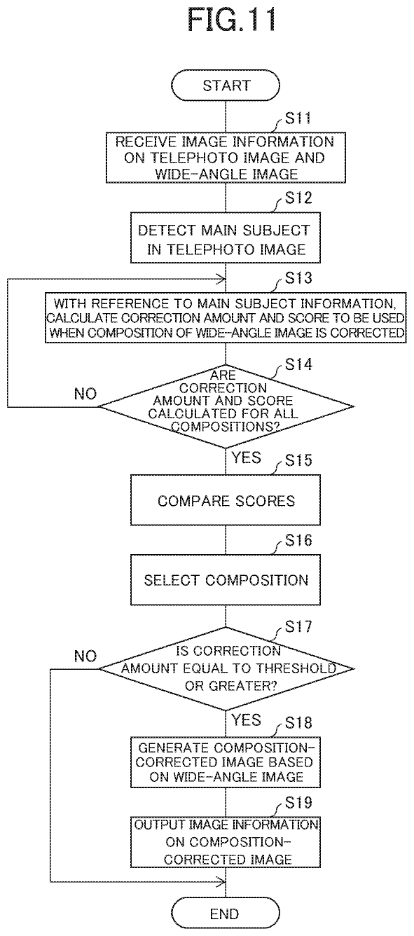

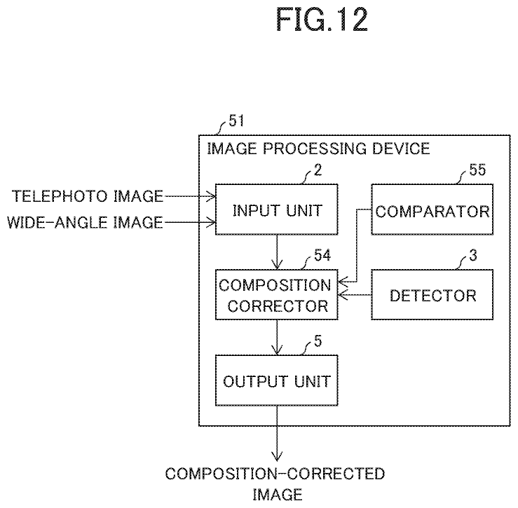

Described below is the second embodiment with reference to FIGS. 11 and 12.

Image Processing Device 51

A not-shown image processing device 51 according to this embodiment is the same in configuration as the image processing device 1 according to the first embodiment, except that the processing device 51 includes the composition corrector 54 instead of the composition corrector 4.

Composition Corrector 54

When outputting a corrected image, the composition corrector 54 determines whether to output a corrected image based on a wide-angle image, depending on a result of comparison between the correction amount of a composition and a threshold. Except for the above feature, the composition corrector 54 is the same in function as the composition corrector 4.

More specifically, if the correction amount for providing the selected composition is smaller than the threshold, the composition corrector 54 keeps from outputting the corrected image having the composition selected based on the wide-angle image. If the correction amount is equal to the threshold or greater, the composition corrector 54 outputs the corrected image having the selected composition.

If the correction amount is small for correcting the wide-angle image to generate the corrected image, the wide-angle image to be input in the input unit 2 and the corrected image to be output from the output unit 5 could be similar to each other. For example, if the correction amount represents a rotation amount of 0°, a translation amount of −1 pixel in a vertical direction, and an area of −1 pixel in the vertical direction in relation to the wide-angle image, the corrected image to be output from the output unit 5 has pixels cropped in the first row of the wide-angle image to be input in the input unit 2. In this case, the wide-angle image and the corrected image are significantly similar to each other. As a result, if the output unit 5 outputs the corrected image and stores the corrected image in a not-shown storage unit, the corrected image similar to the wide-angle image is stored such that the storage region of the storage unit might be unnecessarily reduced.

Hence, when the correction amount is small, the composition corrector 54 keeps from outputting the corrected image similar to the wide-angle image. Such a feature makes it possible to output a corrected image which is not similar to the wide-angle image. As a result, the corrected image to be output can make the user greatly feel an effect of composition correction.

Here, the composition corrector 54 may set the threshold for each of the factors such as a rotation amount, a translation amount, and an area constituting a correction value. The threshold may be set for some or all of these factors. For example, the composition corrector 54 is to set a threshold of the rotation amount to 1°. If the rotation amount among the factors of the correction amount is smaller than 1°, the composition corrector 54 keeps from outputting a corrected image even though other factors exceed the threshold.

Image Processing

Described below is image processing (an image processing method) of the image processing device 51 according to this embodiment, with reference to FIG. 11. FIG. 11 is a flowchart showing an example of the image processing by the image processing device 51.

Steps S11 to S16, S18 and S19 in FIG. 11 are the same as Steps S1 to S8 in FIG. 10. Hence, only Step S17 will be described here.

Step S17: The composition corrector 54 determines whether the correction amount is equal to the threshold or greater. Here, the correction amount is for correcting the wide-angle image to generate an image having the selected composition. If the correction amount for providing the selected composition is equal to the threshold or greater (Step S17: YES), the processing proceeds to Step S18. If the correction amount for providing the selected composition is smaller than the threshold (Step S17: NO); that is, if the correction amount for correcting the wide-angle image to generate the corrected image is smaller than the threshold, the composition corrector 54 keeps from outputting the corrected image and finishes the image processing.

Modification 1 of Composition Corrector 54

In the above example, if the correction amount for providing the selected composition is smaller than the threshold, the composition corrector 54 determines to keep from outputting the corrected image having the composition selected based on the wide-angle image. However, the composition corrector 54 in this embodiment is not limited to the above example. The composition corrector 54 in this embodiment may determine to keep from outputting a corrected image when a cropping area, instead of the correction amount, for cropping the corrected image from the wide-angle image is smaller than a separately determined threshold.

Here, the cropping area is interpreted, for example, as a proportion of the corrected image to the wide-angle image. Note that the cropping area has two factors; namely, a horizontal direction and a vertical direction. A threshold may be provided for each of the factors.

Here, the composition corrector 54 can set as the threshold a value different for each zoom magnification of a telephoto image. For example, the composition corrector 54 may set the threshold higher as the zoom magnification is higher.

When a corrected image to be output has a cropping area smaller than the threshold, the corrected image is low in resolution such that an effect of correcting the composition might be insufficient. In contrast, the composition corrector 54 of the image processing device 51 according to this embodiment keeps from outputting a corrected image having a small cropping area. Such a feature sufficiently achieves the effect of correcting the composition, making it possible to output a more ideally corrected image.

Modification 2 of Composition Corrector 54

Moreover, if the number of the pixels of the selected composition, instead of the correction amount and the cropping area, is smaller than the threshold, the composition corrector 54 may determine keep from outputting a corrected image having the composition selected based on the wide-angle image. Specifically, if the number of the pixels of the corrected image is smaller than the threshold, the composition corrector 54 does not have to output the corrected image.

Here, the composition corrector 54 sets the threshold to a value determined with reference to the number of the pixels in the telephoto image. For example, the composition corrector 54 sets the threshold to N % of the number of the pixels in the telephoto image. When a corrected image to be output has a small number of pixels, the corrected image is low in resolution such that the effect of correcting the composition might be insufficient. In contrast, if the number of the pixels of the selected composition is smaller than the threshold, the composition corrector 54 keeps from outputting a corrected image having the composition selected based on the wide-angle view. Such a feature sufficiently achieves the effect of correcting the composition, making it possible to output a more ideally corrected image.

Modification 3 of Composition Corrector 54

In the above example, the composition corrector 54 sets a threshold not to make a wide-angle image and a corrected image similar to each other, and limits output of the corrected image. However, this embodiment shall not be limited to the above example. The composition corrector 54 in this embodiment may limit the output of the corrected image if, instead of or in addition to the above example, the telephoto image and the corrected image are similar to each other. Here, the composition corrector 54 determines, for example, a similarity between the telephoto image and the output corrected image. If the images are similar to each other, the composition corrector 54 limits the output. After matching the resolutions of the telephoto image and the corrected image, the composition corrector 54 can determine the similarity by comparing the gradation values of the pixels. Moreover, if the correction amount for correcting the telephoto image to generate the corrected image, instead of the similarity, is smaller than the threshold value, the composition corrector 54 may determine to keep from outputting the corrected image having the composition selected based on the wide-angle image. Here, as seen in the case of the threshold for the correction amount for correcting the wide-angle image to generate the corrected image, the composition corrector 54 can set a threshold for each of the factors such as a rotation amount, a translation amount, and an area constituting the correction value, and for some or all of the factors. Hence, if the output of the corrected image is limited when the telephoto image and the corrected image are similar to each other, the composition corrector 54 can output a more ideally corrected image.

Furthermore, if determining that the first subject in the telephoto image is positioned in a distant view and the telephoto image and the corrected image are similar to each other, the composition corrector 54 may limit the output of the corrected image.

When the same main subject is held in focus and captured, the telephoto image and the wide-area image are different in depth of field. Hence, a telephoto image having a blurred background region and a wide-area image thoroughly held in focus are simultaneously captured even if the telephoto image and the wide-area image are similar in composition, making it possible to output a corrected image not similar to the telephoto image. However, if the main subject is found in a distant view of the telephoto image, the depth of field in the telephoto image is great such that the telephoto image and the corrected image are likely to be similar to each other.

In contrast, if the first subject in the telephoto image is positioned in a distant view and the telephoto image and the corrected image are similar to each other, the composition corrector 54 limits the output of the corrected image, making it possible to output a more ideally corrected image.

Modification 4 of Composition Corrector 54

When outputting a corrected image in the above example, the composition corrector 54 determines whether to output a corrected image based on a wide-angle image, depending on the result of the comparison between a correction amount of a composition and the threshold. However, this embodiment shall not be limited to such an example. Described below is Modification 4 of Composition Corrector 54, with reference to FIG. 12. FIG. 12 is a block diagram illustrating a schematic configuration of a modification of the image processing device 51. As illustrated in FIG. 12, the image processing device 51 may further include a comparator 55. Instead of the composition corrector 54, the comparator 55 may determine whether to output a corrected image based on a wide-angle image in accordance with a result of the comparison between a correction amount of a composition and the threshold. Compared with the case where only the composition corrector 54 executes the processing, the comparator 55 can reduce the workload on the composition corrector 54. Note that in the embodiments below, the comparator instead of the composition corrector may set the threshold to limit the output of a corrected image.

### Third Embodiment

In the first embodiment, the composition corrector 4 of the image processing device 1 corrects a composition of a wide-angle image. Alternately, in a third embodiment, a not-shown composition corrector 104 may correct a composition of a telephoto image.

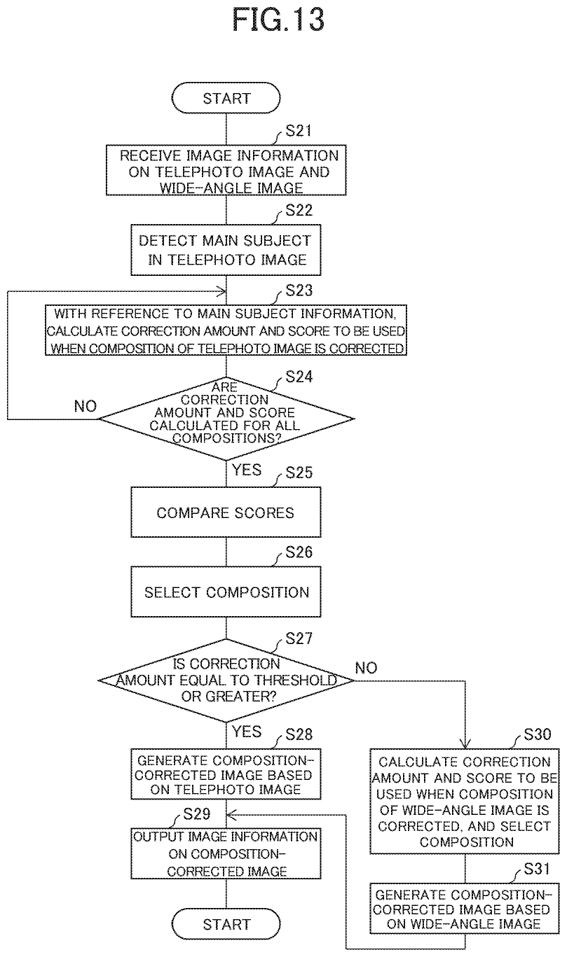

Described below is the third embodiment, with reference to FIG. 13.

Image Processing Device 101

A not-shown image processing device 101 according to this embodiment is similar in configuration to the image processing device 1 according to the first embodiment, except that the image processing device 101 includes the not-shown composition corrector 104 instead of the composition corrector 4.

Composition Corrector 104

Depending on a telephoto image, the composition corrector 104 outputs not a corrected image generated by correcting a wide-angle image but an image generated by correcting a telephoto image. If the telephoto image is in a composition to allow the main subject to be ideally positioned, the composition corrector 104 corrects the composition of the telephoto image to output the corrected image. If not, the composition corrector 104 corrects the composition of the wide-angle image to output the corrected image. The composition corrector 104 can correct the compositions as the composition corrector 4 does. Thus, the descriptions of the correction shall be omitted.

More specifically, the composition corrector 104 calculate a score be used as an index indicating whether the main subject in each of the expected compositions corrected based on the telephoto image is ideally positioned in the composition. Then, if a composition whose score is equal to a threshold or greater is found, the composition corrector 104 corrects the composition of the telephoto image to generate any one of the compositions whose score is equal to the threshold or greater, and outputs the corrected image. Moreover, if no composition whose score is equal to the threshold or greater is found, the composition corrector 104 corrects the composition of the wide-angle image so that the second subject included in the wide-angle image and corresponding to the first subject is used as the main subject, and outputs the corrected image. Such features make it possible to easily output a corrected image whose composition is ideally corrected.

As can be seen, the composition corrector 104 corrects a composition of a telephoto image to generate a corrected image, if the main subject is ideally positioned in the composition of the telephoto image, and the composition can be ideally corrected. If not, the composition corrector 104 corrects a composition of a wide-angle image with reference to the main subject information on the first subject acting as the main subject in the detected telephoto image. Such features allow the composition corrector 104 to output a corrected image whose composition is corrected to be well balanced.

Image Processing

Described below is image processing (an image processing method) of the image processing device 101 according to this embodiment, with reference to FIG. 13. FIG. 13 is a flowchart showing an example of the image processing by the image processing device 101.

Steps S21, S22, S29 and S31 in FIG. 13 are the same as Steps S1, S2. S8 and S7 in FIG. 10. Hence, only Steps S23 to 28 and S30 will be described here.

Step S23: The composition corrector 104 of the image processing device 101 refers to the main subject information on the detected first subject, and calculates a correction amount and a score for each of the expected compositions obtained by correcting the composition of the telephoto image.

Step S24: The composition corrector 104 determines whether the correction amount and the score are calculated for all the compositions obtained by correcting the composition of the telephoto image. If the composition corrector 104 determines that the correction amount and the score are not calculated even for one of the compositions (Step S24: NO), the process goes back to Step S23. If the composition corrector 104 determines that the correction amount and the score are calculated for all the compositions (Step S24: YES), the processing proceeds to Step S25.

Step S25: The composition corrector 104 compares the scores of the compositions for the telephoto image to be corrected.

Step S26: The composition corrector 104 selects a composition having the highest score of all the scores of the compositions as the composition for a corrected image. That is, the composition corrector 104 selects a composition in which the main subject in the telephoto image is positioned most ideally.

Step S27: The composition corrector 104 determines whether the correction amount is equal to the threshold or greater. Here, the correction amount is for correcting the telephoto image to generate an image having the selected composition. If the correction amount for providing the selected composition is equal to the threshold or greater (Step S27: YES), the processing proceeds to Step S28. If the correction amount for providing the selected composition is smaller than the threshold (Step S27: NO), the processing proceeds to Step S30.

Step S28: The composition corrector 104 corrects the composition of the telephoto image based on the selected composition and the correction amount to generate the corrected image. As can be seen, depending on a telephoto image, the composition corrector 104 outputs not a corrected image generated by correcting a wide-angle image but an image generated by correcting a telephoto image (correcting composition).

Step S30: The composition corrector 104 calculates a correction amount and a score for each of the compositions to be expected when the wide-angle image is corrected to have the compositions, and selects a composition having the highest score of all the scores of the compositions as the composition for the corrected image. This step is carried out in the same manner as Steps S3 to S6 in FIG. 10. Hence, the details thereof shall be omitted.

### Fourth Embodiment

In the first embodiment, the composition corrector 4 of the image processing device 1 always outputs a corrected image regardless of a condition of pixels. Alternatively, as described in a fourth embodiment, the composition corrector may function as a not-shown composition corrector 154 which keeps from outputting the corrected image, depending on a condition of pixels.

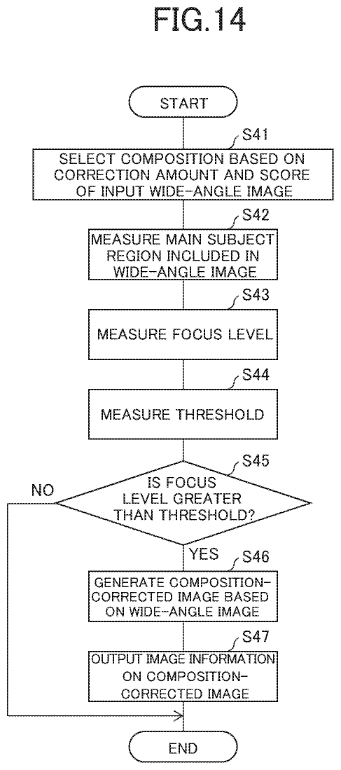

Described below is the fourth embodiment, with reference to FIG. 14.

Image Processing Device 151

A not-shown image processing device 151 according to this embodiment is similar in configuration to the image processing device 1 according to the first embodiment, except that the image processing device 151 includes the composition corrector 154 instead of the composition corrector 4.

Composition Corrector 154

The composition corrector 154 determines whether to output a corrected image based on a condition of pixels in a second subject region included in a wide-angle image and corresponding to a first subject region in a first subject region. The composition corrector 154 keeps from outputting a corrected image in a poor pixel condition such as blur, blocked up shadows, and blown out highlights. Such a feature allows the composition corrector 154 to output only a corrected image whose composition is well balanced and pixels are in a good condition.

Described below is a function of the composition corrector 154, citing a focus level as an example of the pixel condition. Here, the composition corrector 154 either outputs or keeps from outputting the corrected image, depending on a focus level of the second subject in the wide-angle image.

More specifically, the composition corrector 154 first measures the focus level of the second subject region included in the wide-angle image and corresponding to the first subject region in the telephoto image. The composition corrector 154 can measure the focus level with a known technique, using the point spread function (PFS). Next, the composition corrector 154 outputs the corrected image if the focus level of the second subject region is equal to a threshold or greater, and keeps from outputting the corrected image if the focus level is smaller than the threshold. Here, the composition corrector 154 may set the threshold to, for example, a focus level of the first subject region.

For example, if a capturing unit capturing a telephoto image and a capturing unit capturing a wide-angle image cannot synchronize with each other in setting a focus position and an exposure, the telephoto image and the corrected image are captured under a different capturing condition. Hence, no matter how the composition is well-balanced, the corrected image to be output might be low in focus level. Moreover, if the synchronization is possible, the focus position and the exposure of the capturing unit capturing a wide-angle image are set along with the capturing unit capturing a telephoto image. Hence, the telephoto image and the wide-angle image can be captured under the same capturing condition. However, if the second subject region partially lies out of the angle of view of the telephoto image, the state of the region lying out is not reflected on the setting. As a result, the focus level of the region might be low.

In contrast, thanks to the above configuration, the composition corrector 154 keeps from outputting a corrected image having a low focus level, even though the corrected image is in a well-balanced composition. Hence, the composition corrector 154 can output only a corrected image in a well-balanced composition and with a high focus level.

Image Processing

Described below is image processing (an image processing method) of the image processing device 151 according to this embodiment, with reference to FIG. 14. FIG. 14 is a flowchart showing an example of the image processing by the image processing device 151. FIG. 14 shows a case where the composition corrector 154 of the image processing device 151 outputs a corrected image based on a focus level used as an example of a pixel condition.

Step S41 in FIG. 14 corresponds to Steps S1 to S6 in FIG. 10, and the Steps S46 and S47 in FIG. 14 are the same as Steps S7 and S8 in FIG. 10. Hence, only Steps S42 to S45 will be described here.

Step S42: The composition corrector 154 measures the second subject region included in the wide-angle image and corresponding to the first subject region in the telephoto image.

Step S43: The composition corrector 154 measures a focus level of the second subject region.

Step S44: The composition corrector 154 measures a focus level of the first subject region, and sets the focus level as a threshold.

Step S45: The composition corrector 154 either outputs or keeps from outputting the corrected image, depending on the focus level of the second subject in the wide-angle image. More specifically, the composition corrector 154 determines whether the focus level of the second subject region is equal to or greater than the focus level of the first subject region; namely, the threshold. If the focus level of the second subject region is equal to or greater than the threshold (Step S45: YES), the processing proceeds to Step S46. If the focus level of the second subject region is smaller than the threshold (Step S45: NO), the composition corrector 154 keeps from outputting the corrected image and finishes the image processing.

Modification 1 of Composition Corrector 154

In the above example, the composition corrector 154 determines whether to output a corrected image based on a value of a focus level. However, this embodiment shall not be limited to the above example. In this embodiment, the composition corrector 154 may determine whether to output a corrected image, depending on a motion blur amount instead of the focus level. The motion blur amount indicates an amount of blur in a still image. That is, the composition corrector 154 either outputs or keeps from outputting a corrected image, depending on the motion blur amount.

First, the composition corrector 154 measures a motion blur amount of the second subject region with a known motion detection technique. Next, the composition corrector 154 outputs a corrected image if the motion blur amount of the second subject region is equal to a threshold or smaller, and keeps from outputting the corrected image if the motion blur amount of the second subject region is greater than the threshold. Here, the composition corrector 154 may set the threshold to, for example, a motion blur amount of the first subject region. Thanks to the above configuration, the composition corrector 154 keeps from outputting a corrected image whose motion blur amount is small, even though the corrected image is in a well-balanced composition. Hence, the composition corrector 154 can output only a corrected image in a well-balanced composition and with a small motion blur amount.

Modification 2 of Composition Corrector 154

The composition corrector 154 may determine whether to output a corrected image, depending on brightness as a pixel condition, instead of the above example. That is, the composition corrector 154 either outputs or keeps from outputting a corrected image depending on the brightness.

First, the composition corrector 154 measures a brightness of the second subject region with a known technique. Next, the composition corrector 154 outputs the corrected image if the brightness of the second subject region is within a predetermined range, and keeps from outputting the corrected image if the brightness is out of the predetermined range. Here, the composition corrector 154 may determine that the brightness is within the predetermined range if, for example, no blown out highlights or blocked up shadows are found.

If the brightness is out of the predetermined range such as when the image is excessively bright or dark, blown out highlights or blocked up shadows might appear in the image. In contrast, the composition corrector 154 in the above configuration limits the output of the corrected image if the brightness is out of the predetermined range. Thanks to the above configuration, the composition corrector 154 keeps from outputting a corrected image having blown out highlights or blocked up shadows, even though the corrected image is in a well-balanced composition. Hence, the composition corrector 154 can output only a corrected image in a well-balanced composition and without blown out highlights or blocked up shadows.

Modification 3 of Composition Corrector 154

The composition corrector 154 may determine whether to output a corrected image by appropriately combine the determinations of a focus level, a motion blur amount, and a brightness described in the above modifications. For example, the composition corrector 154 may output the corrected image if all of the focus level, the motion blur amount, and the brightness satisfy a determination condition. Such a feature allows the composition corrector 154 to output a well-balanced and ideally corrected image.

### Fifth Embodiment

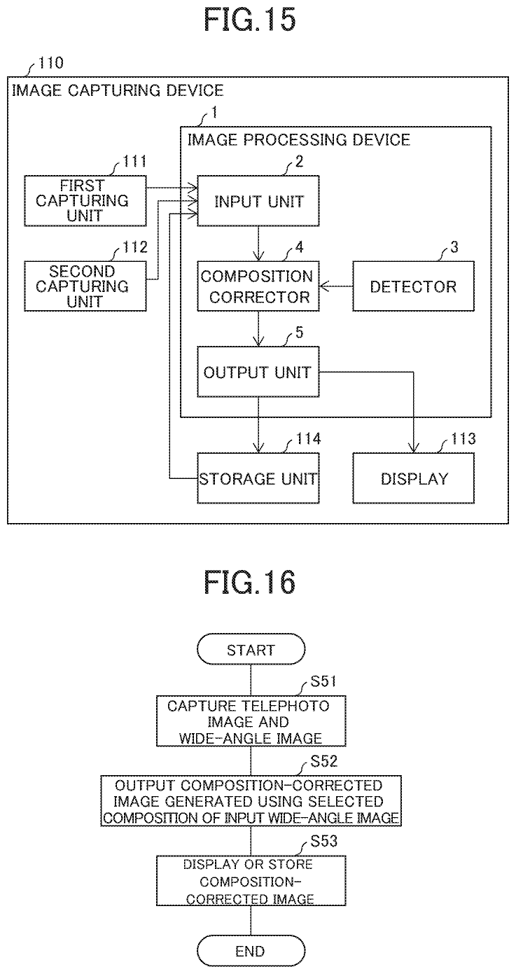

Described below is a fifth embodiment according to the present invention, with reference to FIGS. 15 and 16.

Image Capturing Device 110

FIG. 15 is a functional block diagram illustrating a configuration of an image capturing device 110 according to the fifth embodiment of the present invention. As illustrated in FIG. 15, the image capturing device 110 according to this embodiment includes: the image processing device 1 according to the first embodiment; a first capturing unit 111; a second capturing unit 112, a display 113; and a storage unit 114.

Based on a telephoto image captured by the first capturing unit 111 and a wide-angle image captured by the second capturing unit 112, the image capturing device 110 causes the image processing device 1 to output a corrected image, and either the display 113 to display the corrected image or the storage unit 114 to store the corrected image. Hence, similar to the above image processing device 1, the image capturing device 110 can correct a composition using the wide-angle image, with reference to the first subject in the telephoto image. Even if the first subject lies out of the telephoto image such that it is difficult to correct the composition using the telephoto image, the above features make it possible to output a well-balanced corrected image with the composition ideally corrected.

First Capturing Unit 111 and Second Capturing Unit 112

The first capturing unit 111 captures a telephoto image, and a second capturing unit 112 captures a wide-angle image. The first capturing unit 111 and the second capturing unit 112 each include such capturing elements as a charge coupled device (CCD) sensor, and a complementary metal oxide semiconductor (CMOS) sensor. The first capturing unit 111 captures an image (a still image or a moving image) including the first subject, and the second capturing unit 112 captures an image including the second subject. The first capturing unit 111 and the second capturing unit 112 are different in focal point, and can respectively capture a telephoto image and a wide-angle image.

Display 113

The display 113 displays a corrected image including textual information and main subject information. The display 113 is a display screen such as a liquid crystal display (LCD) and an organic electro luminescence (EL) display. The user may use as a preview the corrected image to be displayed on the display 113, and, as necessary, cause the storage unit 114 to store the corrected image through the input unit 2 while checking the corrected image. An example of the instruction to be sent to the input unit 2 includes an action of the user pressing a shutter button of the input unit 2. Moreover, if the image processing device 1 keeps from outputting the corrected image, the display unit 113 may display the telephoto image.

Storage Unit 114

The storage unit 114 stores such images as a corrected image, a telephoto image, and a wide-angle image in a storage medium, and reads the images stored in the storage medium and outputs the read image to the image processing device 1. Examples of the storage unit 114 include a flash memory and a hard disc.

Image Processing

Described below is image processing (an image processing method) of the image capturing device 110 according to this embodiment, with reference to FIG. 16. FIG. 16 is a flowchart showing an example of the image processing by the image capturing device 110.

Step S52 in FIG. 16 corresponds to Steps S1 to S8 in FIG. 10. Hence, only Steps S51 and S53 will be described here.

Step S51: The first capturing unit 111 and the second capturing unit 112 either capture a telephoto image and a wide-angle image, or read the telephoto image and the wide-angle image from the storage unit 114 and inputs the images in the input unit 2 of the image processing device 1.

Step S53: If the output unit 5 of the image processing device 1 outputs image information on a corrected image to the display 113, the display 113 displays the corrected image. If the output unit 5 outputs the image information on the corrected image to the storage unit 114, the storage unit 114 stores the corrected image.

Modification 1 of Image Capturing Device 110

Described in the above example is the image capturing device 110 including the image processing device 1. Alternatively, the image capturing device 110 may include any one of the image processing devices 51, 101, and 151, instead of the image processing device 1. Here, the image capturing device 110 has the functions of the image processing devices instead of those of the image processing device 1, and can execute all the functions except those of the composition corrector. If any one of the image processing devices 51, 101, and 151 keeps from correcting a composition and outputting a corrected image, the image capturing device 110 may cause the display 113 to display, or cause the storage unit 114 to store, a telephoto image instead of the corrected image.

Modification 2 of Image Capturing Device 110

Moreover, in the above example, the image capturing device 110 causes the display 113 to display either a corrected image or a telephoto image alone. However, this embodiment shall not be limited to this example. In this embodiment, the image capturing device 110 may cause the display 113 to simultaneously display the corrected image and the telephoto image. Here, the user may determine again the composition of the telephoto image, while checking the corrected image to be displayed on the display 113. In this case, when the corrected image obtains an ideal composition, the user can cause the storage unit 114 to store the corrected image through the input unit 2. Note that if the user determines the composition of the telephoto image again such that the telephoto image and the corrected image become similar to each other in composition, the image processing device 1 of the image capturing device 110 may keep from outputting the corrected image, and may cause the display 113 to display, or the storage unit 114 to store, the telephoto image alone.

Modification 3 of Image Capturing Device 110

Moreover, in the above example, the image capturing device 110 includes the storage unit 114. However, the storage unit 114 is not essential, and the image capturing device 110 does not have to include the storage unit 114. In this case, too, the image capturing device 110 can easily output a corrected image whose composition is ideally corrected.

Examples of Control Blocks as Hardware and Software

Control blocks (in particular, the composition correctors 4, 54, 104, and 154) of the image processing devices 1, 51, 101, and 151 may be provided in the form of a logic circuit (hardware) on an integrated circuit (an IC chip), and of software.

In the former case, the control blocks of the image processing devices 1, 51, 101, and 151 may be provided in the form of such hardware as an application specific integrated circuit (ASIC) and a field programmable gate array (FPGA).

In the latter case, the image processing devices 1, 51, 101, and 151 include a computer to execute an instruction of a program which is software performing the functions of the devices. This computer includes, for example, at least one processor (a controller), and at least one computer-readable storage medium storing the program. The storage medium includes an operation system (OS) and hardware such as a peripheral. Moreover, if the computer uses the WWW system, the computer includes an environment to provide (or an environment to display) a web site. In the computer, the processor reads and executes the program from the storage medium so that the object of the present invention is achieved. Examples of the processor include a central processing unit (CPU) and a graphic processing unit (GPU). An example of the storage unit includes a “non-transitory and tangible medium” such as a read only memory (ROM), as well as a tape, a disc, a card a semiconductor memory and a programmable logic circuit. The storage unit may further include a random access memory (RAM) into which the program is loaded. The program may be provided to the computer through any given medium (such as a communications network and a broadcast wave) capable of transmitting the program. Note that an aspect of the present invention can be provided in the form of a data signal included in a carrier wave and embodied when the program is electronically transmitted.

### SUMMARY

The image processing device (1, 51, 101, and 151) according to an aspect of the present invention includes: an obtaining unit (an input unit 2) configured to obtain a first image and a second image larger in angle of view than the first image; a detector (3) configured to detect from the first image a first subject (25) to be a main subject; and a composition corrector (4, 54, 104, and 154) configured to correct the second image to have a composition in which a second subject (7, 12, 15, 17, 18, 19, and 22), included in the second image and corresponding to the first subject (25), is the main subject, and to output a corrected image generated by correcting the second image.

Such features make it possible to easily output a corrected image whose composition is ideally corrected.

In the image processing device (1, 51, 101, and 151) according to a second aspect of the present invention, the composition corrector (4, 54, 104, and 154) may correct the second image based on a position of the first subject (25) in the first image.

In the above feature, the second image is corrected based on the position of the first subject in the first image. Hence, the second subject is kept from lying out of the second image, making it possible to output a corrected image whose composition is ideally corrected.

In the image processing device (51) according to a third aspect of the present invention, the composition corrector (54) according to the first or second aspect may keep from outputting the corrected image if a correction amount for correcting the second image to generate the corrected image is smaller than a threshold.

In the above feature, the composition corrector can output a corrected image which is not similar to the second image. As a result, the corrected image to be output can make the user feel an effect of composition correction.

In the image processing device (51) according to a fourth aspect of the present invention, the composition corrector (54) according to any one of the first to third aspects may keep from outputting the corrected image if the number of pixels of the corrected image is smaller than the threshold.

In the above feature, the composition corrector keeps from outputting a corrected image generated from the second image and having a selected composition, if the number of pixels in the selected composition is smaller than the threshold. Such a feature sufficiently achieves the effect of correcting the composition, making it possible to output a more ideally corrected image.

In the image processing device (101) according to a fifth aspect of the present invention, the composition corrector (104) according to any one of the first to fourth aspects may keep from outputting the corrected image, depending on the first image, and outputs an image generated by correcting the first image.

In the above feature, the composition corrector can output a corrected image whose composition is corrected to be well balanced.

In the image processing device (151) according to a sixth aspect of the present invention, the composition corrector (154) according to any one of the first to fifth aspects may either output or keep from outputting the corrected image, depending on a condition of pixels of the second subject in the second image.

In the above feature, the composition corrector keeps from outputting a corrected image in a poor pixel condition such as blur, blocked up shadows, and blown out highlights. Such a feature makes it possible to output only a corrected image whose composition is well balanced and pixels are in a good condition.

In the image processing device (151) according to a seventh aspect of the present invention, the composition corrector (154) according to any one of the first to sixth aspects may either output or keep from outputting the corrected image, depending on a focus level of the second subject in the second image.

In the above feature, the composition corrector keeps from outputting a corrected image having a low focus level, even though the corrected image is in a well-balanced composition. Such a feature makes it possible to output only a corrected image in a well-balanced composition and with a high focus level.

In the image processing device (151) according to an eighth aspect of the present invention, the composition corrector (154) according to any one of the first to seventh aspects may either output or keep from outputting the corrected image, depending on a motion blur amount of the second subject in the second image.

In the above feature, the composition corrector keeps from outputting a corrected image whose motion blur amount is great, even though the corrected image is in a well-balanced composition. Such a feature makes it possible to output only a corrected image in a well-balanced composition and with a small motion blur amount.

In the image processing device (151) according to a ninth aspect of the present invention, the composition corrector (154) according to any one of the first to eighth aspects may either output or keep from outputting the corrected image, depending on brightness of the second subject in the second image.

In the above feature, the composition corrector keeps from outputting a corrected image having blown out highlights or blocked up shadows, even though the corrected image is in a well-balanced composition. Such a feature makes it possible to output only a corrected image in a well-balanced composition and without blown out highlights or blocked up shadows.

In the image processing device (1, 51, 101, and 151) according to a tenth aspect of the present invention, the first subject (25) according to any one of the first to ninth aspect may be a face.

The detector in the image processing device can ideally detect the first subject in particular when the first subject is a face.

An image capturing device (110) according to an eleventh aspect of the present invention includes: a first capturing unit (111) configured to capture a first image; a second capturing unit (112) configured to capture a second image larger in angle of view than the first image; an obtaining unit (an input unit 2) configured to obtain the first image and the second image larger in angle of view than the first image; a detector (3) configured to detect from the first image a first subject (25) to be a main subject; a composition corrector (4, 54, 104, and 154) configured to correct the second image to have a composition in which a second subject (7, 12, 15, 17, 18, 19, and 22), included in the second image and corresponding to the first subject (25), is the main subject, and to output a corrected image generated by correcting the second image; and a display configured to display (113) the corrected image.

The image capturing device according to an aspect of the present invention achieves an effect similar to that of the image processing device according to an aspect of the present invention.

An image processing method according to a twelfth aspect of the present invention includes: obtaining a first image and a second image larger in angle of view than the first image; detecting from the first image a first subject (25) to be a main subject; and correcting the second image to have a composition in which a second subject (7, 12, 15, 17, 18, 19, and 22), included in the second image and corresponding to the first subject (25), is the main subject, and outputting a corrected image generated in correcting the second image.

The image processing method according to an aspect of the present invention achieves an effect similar to that of the image processing device according to an aspect of the present invention.

The image processing device (1, 51, 101, and 151) according to the aspects of the present invention may be provided in the form of a computer. In such a case, the computer is run as features (software features) included in the image processing device (1, 51, 101, and 151) so that a control program of the image processing device (1, 51, 101, and 151) provided in the form of the computer and a computer-readable storage medium storing the control program are included in the scope of the present invention.

The present invention shall not be limited to the embodiments described above, and can be modified in various manners within the scope of claims. The technical aspects disclosed in different embodiments are to be appropriately combined together to implement an embodiment. Such an embodiment shall be included within the technical scope of the present invention. Moreover, the technical aspects disclosed in each embodiment are combined to achieve a new technical feature.

1. An image processing device comprising:
an obtaining unit configured to obtain a first image and a second image larger in angle of view than the first image;
a detector configured to detect from the first image a first subject to be a main subject; and
a composition corrector configured to correct the second image to have a composition in which a second subject, included in the second image and corresponding to the first subject, is the main subject, and to output a corrected image generated by correcting the second image.

2. The image processing device according to claim 1, wherein
the composition corrector corrects the second image based on a position of the first subject in the first image.

3. The image processing device according to claim 1, wherein
the composition corrector is configured to keep from outputting the corrected image if a correction amount for correcting the second image to generate the corrected image is smaller than a threshold.

4. The image processing device according to claim 1, wherein
the composition corrector keeps from outputting the corrected image if the number of pixels of the corrected image is smaller than a threshold.

5. The image processing device according to claim 1, wherein
the composition corrector keeps from outputting the corrected image, depending on the first image, and outputs an image generated by correcting the first image.

6. The image processing device according to claim 1, wherein
the composition corrector either outputs or keeps from outputting the corrected image, depending on a condition of pixels of the second subject in the second image.

7. The image processing device according to claim 1, wherein
the composition corrector either outputs or keeps from outputting the corrected image, depending on a focus level of the second subject in the second image.

8. The image processing device according to claim 1, wherein
the composition corrector either outputs or keeps from outputting the corrected image, depending on a motion blur amount of the second subject in the second image.

9. The image processing device according to claim 1, wherein
the composition corrector either outputs or keeps from outputting the corrected image, depending on brightness of the second subject in the second image.

10. The image processing device according to claim 1, wherein
the first subject is a face.

11. An image capturing device comprising:
a first capturing unit configured to capture a first image;
a second capturing unit configured to capture a second image larger in angle of view than the first image;
an obtaining unit configured to obtain the first image and the second image larger in angle of view than the first image;
a detector configured to detect from the first image a first subject to be a main subject;
a composition corrector configured to correct the second image to have a composition in which a second subject, included in the second image and corresponding to the first subject, is the main subject, and to output a corrected image generated by correcting the second image; and
a display configured to display the corrected image.

12. An image processing method comprising:
obtaining a first image and a second image larger in angle of view than the first image;
detecting from the first image a first subject to be a main subject; and
correcting the second image to have a composition in which a second subject, included in the second image and corresponding to the first subject, is the main subject, and outputting a corrected image generated in correcting the second image.

13. (canceled)
